(19) United States
(12) Patent Application Publication
(10) Pub. No.: US 2016/0224692 A1
(43) Pub. Date: Aug. 4, 2016

(54) Method for Product Design

(71) Applicant: The Procter & Gamble Company, Cincinnati, OH (US)

(72) Inventors: John Boyet Stevens, Mason, OH (US); William Handy Hartt, IV, Mason, OH (US)

(21) Appl. No.: 14/613,447

(22) Filed: Feb. 4, 2015

(51) Int. Cl. G06F 17/50

(52) U.S. Cl. CPC G06F 17/50

(57) ABSTRACT

Computer implemented methods for creating a product design, include: providing a representation of a package, providing a representation of a consumable product portion, and either: calculating pressure versus mass flow rate for the product using the product viscosity vs. shear-rate response, then calculating package deformation associated with one or more product dispensing events using the pressure versus mass flow rate of the product; and/or calculating package pressure versus squeeze force associated with dispensing the consumable product according to a complex viscosity vs. shear-rate response of the consumable product, and calculating package deformation associated with the package pressure; then altering a design of the package and/or the consumable product portion according to the calculated package deformation. The package representation includes a package body and a package closure including a dispensing orifice. The consumable product representation includes product viscosity vs. shear-rate response data.

### FIELD OF THE INVENTION

The invention relates to computer implemented processes and methods for the design of products. The invention relates particularly to methods for the design of consumer products and packaging.

### BACKGROUND OF THE INVENTION

Packaged consumer products are well known. Such products include liquids provided in a package from which the product must be dispensed. The consumer experience of using the product includes the act of dispensing the product from the package. The design of the package—including any dispensing orifice of the package, together with the package materials, and product characteristics contribute to the consumer experience. The dispensing of the product from the package may change over the lifecycle of the package as the product is dispensed in a series of dosing events. Traditional package design, including the machining of prototype molds for the creation of test packages, consumes significant time and financial resources. In instances where the prototype package is determined to be unsuitable, such a process provides no clear indication of how the product or package may be altered to result in an overall consumer offering which is suitable. What is needed is a method for the design of an overall product—consumable portion plus package—which allows a designer and/or manufacturer to take into consideration the dispensing experience and does so in a cost effective and efficient manner.

### SUMMARY OF THE INVENTION

In one aspect, the computer implemented method for creating a product design includes steps of: providing representations of a package and a consumable product; calculating pressure versus mass flow rate for the product and orifice combination using the product viscosity vs. shear-rate response; calculating the package pressure developed within the package body and the package deformation associated with dispensing using the pressure versus mass flow rate of the combination; and altering a design of the package and/or the consumable product portion according to the calculated package deformation.

In one aspect, the method includes steps of: providing a representation of a package, providing a representation of a consumable product portion, the representation comprising product viscosity vs. shear-rate response; simulating the interaction of the fluid consumable product and the package via a coupled simulation of the interaction. The fluid-structure interactions between the product and package and between product and closure may be solved via a combination of finite element analysis and computational fluid dynamics analysis in a coupled fashion. The results of this analysis may then be used to alter the design of the product package, consumable or package closure.

In one aspect, the two methods described above may be used in combination. In this aspect, a coarse overview of a range of package—dispensing orifice—consumable product may be evaluated by simulating the performance of the product—orifice combination according to the product viscosity vs. shear-rate response, then using that result in conjunction with the package deformation simulation to identify package—orifice—product combinations of particular interest which may then be evaluated using a more comprehensive fluid structure interaction.

### DETAILED DESCRIPTION OF THE INVENTION

As used herein, product refers to a composite of a consumable substance and its associated packaging. Product refers particularly to the primary packaging from which a consumer dispenses portions of the consumable product for use. Exemplary products include: shampoos and conditioners, body washes, surface cleaners, dish care products, fabric care products and dentifrice compositions. Consumable products may include liquids as well as powders.

As used herein, a dispensing or dosing event or cycle refers to the sequence of events resulting in the dispensing of product from the package. The event may constitute the dispensing of a small or large amount of product depending upon the particular consumable product, package and dispensing orifice, and desired consumable quantity being simulated.

In one embodiment, the method for creating a product design includes: providing a representation of a package, the representation comprising a package body and a package closure including a dispensing orifice. The representations may be provided as CAD files in an electronic form or as a file captured via scanning an object using a laser scanner, CAT, PET, or NMR scanner. The representation may include information relevant to the geometry and three-dimensional aspects of the package, package closure and dispensing elements, in addition to information relating to the response of the materials comprising the package and closure to stresses. Exemplary aspects of dispensing element geometry include: orifice geometry and length as well as the path a consumable product follows during dispensing and the tortuosity of that path.

The package may be comprised of flexible materials including metal film, polymer films as well as thicker polymer structures which could include blow-molded, injection molded or thermo-formed structures. The package and closure may comprise a single structure or a composite structure. In one embodiment, the closure may comprise a distinct element. The distinct closure element may comprise a flexible or rigid component and may be injection molded or formed by other means known in the art. The closure may be flexible with a geometry that varies as a function of fluid pressures.

The method further includes providing a representation of the consumable product including product density and viscosity information. Density and viscosity information may be described as a function of temperature. The information may include a function associated with the products viscosity vs. shear-rate response. The viscosity vs. shear-rate response may be provided as a standard function, or may be determined using a rheometer and fitting a function to the observed rheology data. The viscosity function may be related to the transient viscosity of the material or a steady state viscosity function. In one embodiment, an oscillatory rheometer may be used to collect data for the determination of the complex viscosity of the product.

The product data may be used in conjunction with product dispensing orifice data to model the flow of product through the orifice under a range of pressures for the purpose of determining the pressure versus mass flow rate function of the combination of product and orifice geometry. This model may be constructed using Computational Fluid Dynamics (CFD) software, such as AcuSolve from Altair, Star-CCM+ from CD-Adapco or ABAQUS, from Dassault Systemes'. Alternatively, the pressure versus mass flow rate may be determined experimentally using actual package and product elements wherein the package has been adapted with appropriate instrumentation to enable the recording of product flow rate and package internal pressures. In an embodiment including an orifice geometry that can vary according to fluid pressure, the fluid-structural interaction model would entail interaction between CFD software and structural software.

The pressure versus mass flow rate for the consumable product—orifice combination may be used together with the material properties of the package in a Finite Element Analysis (FEA) to model the performance of the consumable-package combination as the consumable is dosed from the package. The model may be developed by simulating the application of forces to portions of the package and the corresponding package pressure which develops within the package body during a dispensing event—emulating for example the opposing forces which would be applied by squeezing the package with a user's fingers. By defining a unit dose to be dispensed, multiple dosing cycles may be simulated from a full package state to any point of partially full, up to and including empty. The model/simulation may utilize FEA or a combination of FEA and CFD (computational fluid dynamics) to assess the performance of the product representations. The simulations may include the steps of hydrostatic loading, sealing, opening the closure, dispensing cycle, release of dispense loading, re-sealing and relaxation over time. The sealing step refers to the removal of the pressure boundary conditions on the cavity reference nodes governing their pressure change. The opening of the closure refers to the activation of the fluid exchange component by modifying the pressure boundary conditions of the exterior allowing the product to exit through the orifice. The relaxation step refers to the calculation of the decay in residual stresses in the package, incremental deformation of the package and the associated change in the internal pressure state.

The pressure versus mass flow rate may be used to calculate the squeeze force necessary to dose a consumable from the package and also the squeeze force history, or the squeeze force function associated with the progression from a zero squeeze force, through a maximum force and back to a zero squeeze force for each dispensing event as well as the calculation of an aggregate squeeze force history for the package, orifice, consumable combination.

In addition to the application of a squeezing force, the simulation may also take into consideration the hydrostatic loading applied to the package by the consumable product when the package is oriented in a position suitable for dispensing the consumable. The simulation may further take into consideration the vacuum loading upon the package associated with opening a package oriented such that the dispensing orifice is disposed below, and not in direct communication with the package headspace, such that a vacuum load arises within the package as the consumable becomes motivated to flow through the dispensing orifice.

In one embodiment, the hydrostatic loading of the package due to the fluid product may be simulated by concurrently applying a gravitational force to the fluid column and venting the headspace of the package. For the venting, the headspace pressure may be defined as equivalent to the ambient atmospheric pressure. Once the combination has achieved equilibrium after the application of gravity, the headspace may be redefined as sealed rather than vented such that subsequent change in the package interior volume and consumable content may be appropriately reflected in the calculated response of the package—orifice—consumable system to the changes.

In one embodiment, the simulation may proceed as a series of dispensing events. The product representation may include distinct volumes for each of the liquid product and the gas filled headspace of the package. The interface between the liquid and gas portions may be defined as a flexible membrane. As the series of dispensing events proceeds, the membrane will deform to accommodate the reduction in the liquid volume associated with each event. The deformation may continue with each event and may limit the number of events which may be reliably simulated. Deformation of the membrane to an extent that a portion of the membrane extends beyond the package via the dispensing element may render the simulation unstable.

One means for extending the number of dispensing events which may be reliably simulated includes defining a series of interface membrane locations. Exemplary locations would be at four equally spaced locations along the vertical axis of the package, each location associated with a particular liquid portion height within the package. As the series of event simulations proceeds, the location of the interface membrane may be progressively shifted down the package. This shifting of the membrane location reduces the likelihood that the deformation of the membrane associated with any single dispensing event will result in a model instability due to the membrane passing through the dispensing orifice.

Another means of accommodating the instability associated with a deforming membrane includes defining a single composite fluid volume rather than distinct liquid and gas volumes. The properties of the single volume may be altered after each dispensing event in association with the changing liquid/gas ratio remaining within the package after the event.

In one embodiment, (the Fully-Coupled Squeeze, FCS method) the interaction of the fluid consumable product and the package may be simulated with a higher fidelity via a coupled simulation of the interaction. In such an embodiment, the fluid-structure interactions between the product and package and between product and closure may be solved via finite element analysis (e.g.: ABAQUS) and computational fluid dynamics analysis (e.g.: AcuSolve, Star-CCM+, ABAQUS CFD) in a coupled fashion. The coupling may be achieved using the Simulia co-simulation engine. In one embodiment, for each time increment of the analysis, the nodal displacements are calculated in the FEA code and transmitted to the CFD code. The CFD code then morphs the Eulerian mesh according to the calculated nodal displacements of its exterior boundary and calculates the resulting flow field and pressure distribution. The calculated pressure distribution is then communicated back to the FEA code as an internal force vector thereby applying the updated pressure distribution to the structural analysis. This co-simulation procedure may be conducted with the FEA code leading, the CFD code leading or concurrently.

When one code is leading and either the FEA or CFD code is executing calculations in the co-simulation, the other code is paused until that code completes its calculation. If the concurrent method is used, both codes are constantly calculating and will automatically pause whenever there is an indicated need to pass information to the other. The fluid flow velocity field may be calculated everywhere in the bottle, orifice and external environment at each time increment of the analysis. The flow of the viscous liquid out of the bottle may be visualized using iso-surface rendering combined with transparency to yield a reasonably realistic visualization of the liquid dispensing event. Similarly, the suck-back of an air bubble from the external environment, through the dispensing element and into the package body, upon release of the squeeze load, may be calculated and visualized.

Model Setup:

The FCS method requires a Lagrangian structural shell element FEA mesh representing the exterior boundary of the bottle. Optionally, the closure/orifice may be meshed using continuum elements. In one embodiment, the FCS method also requires an Eulerian finite volume mesh of the interior volume contained by the bottle including the reduced section corresponding to the orifice which may consist polyhedral elements, hexahedral elements, or combinations thereof, throughout the large uninterrupted regions combined with polyhedral elements to stitch up the regions to the boundaries of the Lagrangian FEA mesh. The model is initialized by assigning all the cells below the liquid—gas interface with liquid properties and all those above the interface with gas (typically air) properties. The liquid is modeled using some appropriate viscosity model derived from the appropriate rheological tests. In some cases, the use of complex viscosity as measured from small amplitude oscillatory rheometer tests will provide the best viscosity model. The complex viscosity model may be combined with a standard viscosity model. A hybrid viscosity model comprised of a complex model, a standard model and fitted to data from physical trials, may also be used.

The simulation results may be used to evaluate the consumer experience and package performance over the lifecycle of uses of the package in dispensing the consumable product. The results may indicate that the consumer experience may be improved by changes to the package materials, package structure (e.g. size, geometry, wall thickness distribution) consumable product characteristics (e.g. consumable product viscosity vs. shear-rate response), or the dispensing orifice geometry. Altered versions of the product offering may also be evaluated using the method. In one embodiment, a range of possible characteristics and designs may be evaluated to determine the efficacy of the product performance and consumer experience in terms of the dispensing of the consumable from the package including the performance of the orifice during and after dispensing, the work required to dispense a particular dose of product, and the appearance of the dosed product upon a target or receiving surface after the product has been dispensed from the package. The simulation method may further be use to consider and evaluate such things as the messiness or lack thereof, of the orifice and the product combination

The methods may be practiced to provide data including the mechanical work associated with a single dispensing event or a sequence of events. The methods may further provide data regarding the pressure within the package during one or more events (package pressure). The mechanical work and pressure data may be used to evaluate and characterize package/consumable product combinations. The data may be considered in conjunction with benchmarks and standards associated with product research data associated with consumer preferences relating to the dispensing event.

The methods include steps associated with altering the package and/or consumable portion of the product offering. The design of the package elements including the package body, the closure element and the dispensing orifice may be altered in association with the data developed during the simulations to achieve a change in the outcome of the simulation that is considered favorable. The design and/or formulation consumable portion of the product may be altered as a result of the simulations of the method in order to achieve a desired dispensing outcome, or an outcome demonstrably different from an earlier simulation outcome.

The methods of the invention may be carried out using a personal computer or PC. As used herein, the term “personal computer” (or “PC”) refers to a computer associated with a particular user or a particular user's household, rather than a centralized server or other computer system which processes or stores data for a plurality of users or households. However, the term “personal computer” is not limited to traditional desktop computers. Rather, “personal computer” generally includes any computing device having a CPU, memory, a visual display device (e.g., a display screen, a printer, etc.), and an input device (e.g., a keyboard, mouse, touch sensitive screen, etc,). By way of example, a personal computer may include a desktop PC, a notebook PC, a tablet PC, a personal digital assistant (PDA), a wireless computing device such as a cell phone or automobile computer, an interactive TV, an Internet appliance, or the like. The PC may further include software application native to the device as well as software application served to the PC over a network connection (either a wired or wireless connection).

The methods of the invention may be programmed for computation on a system of multiple processing cores to increase the overall computing performance and to reduce the processing time associated with accomplishing the performance of the method.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for creating a product design, the method comprising steps of:
providing a representation of a package, the representation comprising a package body and a package closure including a dispensing orifice;
altering a design of the package and/or a consumable product portion according to a calculated package deformation;
wherein the package deformation is calculated by the further steps of:
providing a representation of a consumable product portion, the representation comprising product viscosity vs. shear-rate response;
calculating pressure versus mass flow rate for the product using the product viscosity vs. shear-rate response;
calculating package deformation associated with dispensing the consumable product using the pressure versus mass flow rate of the product; and/or by the further steps of:
providing a representation of a consumable product portion, the representation comprising product complex viscosity vs. shear-rate response;
calculating package pressure versus squeeze force associated with dispensing the consumable product using the consumable product complex viscosity vs. shear-rate response;
calculating package deformation associated with the package pressure.

2. The method according to claim 1 further comprising the step of calculating a squeeze force history associated with dispensing according to the pressure versus mass flow rate for the product.

3. The method according to claim 1 further comprising a step of: calculating package deformation according to product hydrostatic loading.

4. The method according to claim 1 further comprising a step of: calculating package deformation according to package vacuum loading.

5. The method according to claim 1 wherein the step of altering the package design comprises altering the package body design.

6. The method according to claim 1 wherein the step of altering the package design comprises altering the closure design.

7. The method according to claim 1 wherein the step of altering the consumable product portion comprises altering the viscosity vs. shear-rate response of the consumable product portion.

8. The method according to claim 1 further comprising the step of calculating the mechanical work associated with one or more dispensing events of the consumable product via the dispensing orifice.

9. The method according to claim 1 further comprising the step of calculating the package pressure associated with one or more dispensing events of the consumable product via the dispensing orifice.
